(19) United States
(12) Patent Application Publication
(10) Pub. No.: US 2009/0128085 A1
(43) Pub. Date: May 21, 2009

(54) Integrated Wind and Solar Power Generting Structure

(76) Inventor: Fu-Hung Yang, Pingjihen City (TW)

Correspondence Address: HDLS Patent & Trademark Services, P.O. BOX 220746, CHANTILLY, VA, 20153-0746, US

(21) Appl. No.: 11/942,026

(22) Filed: Nov. 19, 2007

(51) Int. Cl. H02J 7/00; H01M 10/46

(52) U.S. Cl. 320/101; 290/1 R

(57) ABSTRACT

An integrated wind and solar power generating structure has a box shape for facilitating moving, installing, disassembling so as to help promotion. The structure includes a foundation disposed on the ground for supporting the weight of the structure. The foundation has a flagpole for a set of connecting rods to be installed and to rotate on the flagpole. The set of connecting rods includes a plurality of connecting rods connected in series, wherein a wind turbine is installed on the topmost connecting rod for generating wind power. The structure also includes a shaft mechanism having a first end axially connected to a lower end of the set of connecting rods and a second end axially connected to the foundation respectively, and a labor-saving retractable device for driving the set of connecting rods to erect or lay down the wind turbine on the set of connecting rods with regard to an axis of the flagpole. Besides, the foundation has a battery, an electronic controlling device disposed therein to receive power from the wind turbine and a solar panel. The set of connecting rods has each connecting rod disposed with a rope ring and a rope, the rope extends and fixes to a fixed position on the ground when the set of connecting rods is erected or laid down. Besides, a supporting rod is additionally disposed and fixed on the ground, so that when the set of connecting rods is laid down, it was laid upon the supporting rod and tied up to the supporting rod and other immobile objects nearby.

### BACKGROUND OF THE INVENTION

1. Field of the Invention

The present invention is related to an integrated wind and solar power generating structure, and more particularly, to an integrated wind and solar power generating structure which is easy to disassemble, store or move, it is also easy to install for providing electricity, and it is easy to store in a container when there's a nature disaster happening, therefore, the integrated wind and solar power generating structure is accessible to the masses due to its simplicity and easy for people to retrieve wind and solar power.

2. Description of the Prior Art

Since electricity is used, the civilization has leapt forward. Electricity has greatly enhanced people's lives and made enormous improvement to human's society.

However, the massive demands for electricity had led to great consumption of all kinds of natural fuels, such as oil, coal and gas. The resources are depleted, and what's more is the damage to the earth. Scientists may have different opinions towards global warming, but there's no doubt that the environment had been changed a great deal since the industrial revolution. All kinds of bad influences such as greenhouse effect, El Nino phenomenon, pollutions, desertification, acid rain and species extinctions are due to humanity's lust. The results are depleted natural resources and environmental pollution, which could to a full-scale extinction.

Fortunately, under the advocating of environmental protection groups, most people are now aware of the current situation and seeking for alternatives to replace the fossil fuel. The alternative and renewable energies such as wind power, solar power and tidal power, are characterized in that they are pollution free and recyclable. Wind power has been in use for centuries, and windmills are used to grind wheat for producing flour. Since electricity is used, windmills are applied to generate wind power and to replace some of the capacities of the thermal power plant to reduce natural resource consumption.

However, wind power has its own limitation and therefore it cannot effectively replace the use of thermal power. First, wind power requires good wind source, wherein location, season and weather are all related factors; second, the transfer efficiency of wind power is low, the wind turbine has to be big in order to achieve the required capacity, but large wind turbine structure means difficulties in installation, maintenance and mobility. It is not possible to move a large wind turbine to a shelter even though in harsh weather, which could lead to the damage of the wind turbine. Furthermore, the cost to install wind turbine is high. It usually takes more than ten groups of worker to construct the wind turbine, such as digging the foundation and using a crane to carry the wind turbine to the site. The complexity and the cost in building up the wind turbine makes it not a popular option for remote districts in considering renewable energy source.

The structure of a solar power generating system has been reduced to a few solar panels, but as to the installation work, it takes professional workers to dig the foundation, build up the frame work, wire the solar panel, battery and electronic controlling device. Due to the above mentioned difficulties, it is hard to promote solar power generator either.

In view of the above-described deficiencies of traditional power generating techniques, after years of constant effort in research, the inventor of this invention has consequently developed and proposed a new integrated wind and solar power generating structure in the present invention.

### SUMMARY OF THE INVENTION

It is an object of the present invention to provide an integrated wind and solar power generating structure, which is easy to disassemble and assemble according to the environment and weather, and is also easy to operate to provide electricity in any time.

It is another object of the present invention to provide an integrated wind and solar power generating structure, which is easy to adjust to achieve the most wind power and solar power generating efficiency so as to reduce the power generating cost of wind and solar power.

It is still another object of the present invention to provide an integrated wind and solar power generating structure, which is easy to maintain and replace, moreover, this structure can be disassembled and stored immediately when there's a nature disaster happening, therefore it is possible to reduce damage.

The present invention discloses an integrated wind and solar power generating structure, which comprises a foundation disposed on the ground for supporting the weight of the whole structure; a flagpole is disposed on the foundation for axially connected a set of connecting rods, the set of connecting rods comprising a plurality of connecting rods, a connecting rod at the lower end being axially connected to the flagpole for the set of connecting rods to move around an axle of the flagpole, the topmost connecting rod of the set of connecting rods being disposed with a wind turbine for generating wind power; and the set of connecting rods and the foundation is connect by a labor-saving retractable device, which can comprises multiple mechanism or can be a jack, a screw, a hydraulic press, or a crane. The labor-saving retractable device is formed in T shape, while two ends are fixed to the foundation, and a third end is axially connected to a lower end of the set of connecting rods. The wind turbine is connected to the top of the set of connecting rods through an axle when the labor-saving retractable device is in operation to drives the set of connecting rods to rotate around the axle, therefore one single user can operate the wind turbine disposed on the set of connecting rods to erect or to lay down. When the wind turbine is erected, it will accept wind force to generate power, and when the wind turbine is laid down, it is easy to install, disassemble, maintain, store and to prevent damage from natural disasters.

The foundation has a flagpole disposed at its center and a solar panel installation area for installing solar panel, and the foundation further includes a electrical appliance space for disposing the battery and the electronic controlling device, a connecting rod sink, a solar panel container, and all kinds of labor-saving installation area The foundation has a lower end screw mounted to a ballast tank, the ballast tank comprises non-leaking plates with iron bars disposed therein, the ballast tank is first filled with water to support the structure when installed, therefore the heavy wind turbine on the tail end of the set of connecting rods can be erected, and when the wind turbine is erected, it is tied up by ropes, until other components have been installed, sandstone or cement can fill in the ballast tank to balance the weight. If the structure is intended to be mobile, one can fill in the tank with water for the safety of the operation, and when the structure is to be moved away, one can drain out the water then move the structure easily.

### BRIEF DESCRIPTION OF THE DRAWINGS

The drawings disclose an illustrative embodiment of the present invention which serves to exemplify the various advantages and objects hereof, and are as follows:

FIG. 1 is a perspective view of the present invention;

FIG. 2 is a perspective view of some of the parts of the structure in the present invention;

FIG. 3 is a perspective view of the wind turbine in operation;

FIG. 4A, FIG. 4C, FIG. 4E, and FIG. 4G show the process of the set of connecting rods being lifted from laid flat to erect for generating wind power;

FIG. 4B, FIG. 4D, FIG. 4F, FIG. 4H show the enlarging view of FIG. 4A, FIG. 4C, FIG. 4E, and FIG. 4G; and

FIG. 5 shows the structure of the foundation in the present invention.

### DETAILED DESCRIPTION OF THE PREFERRED EMBODIMENT

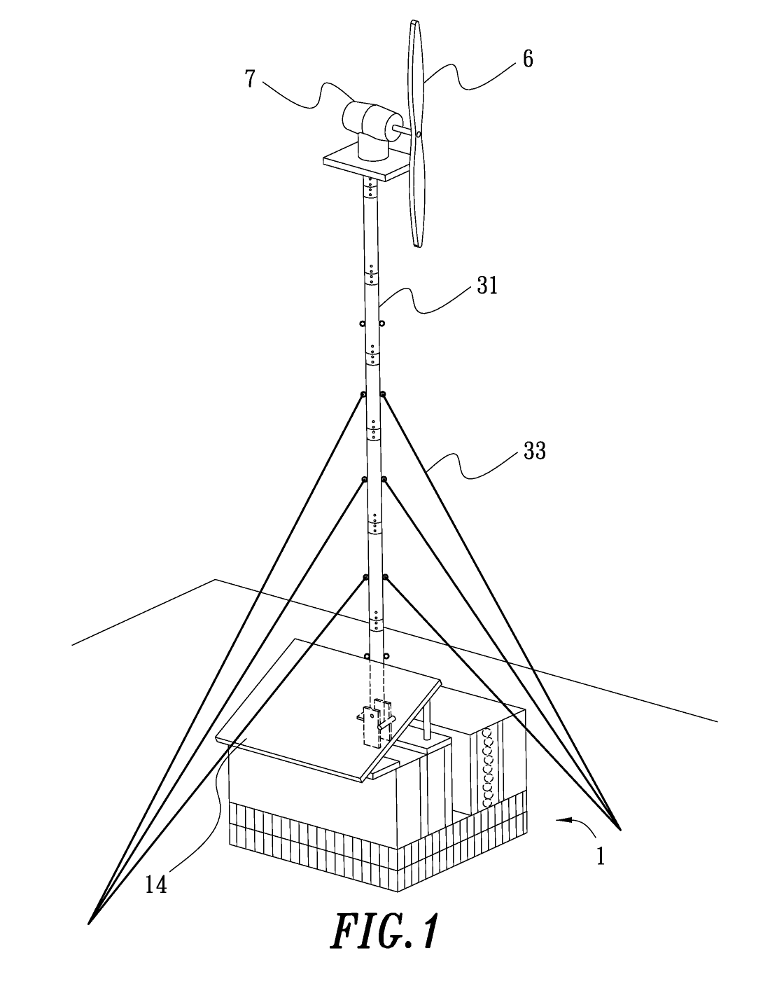

Please refer to FIG. 1 to FIG. 4, the present invention provides an integrated wind and solar power generating structure, which mainly comprises a foundation 1, a flagpole 2, a set of connecting rods 3, a shaft mechanism 4, a labor saving mechanism 5. The foundation 1 is used to support the weight of the whole structure and to provide container space for storing components. The foundation 1 is disposed on the ground, while the ballast tank 11 is filled with water, sandstone, cement or metal [symbol] metal bulk to increase weight, wherein steel bars are disposed to strengthen the ballast tank 11 so as to let the foundation 1 be fixedly disposed on the ground. The flagpole 2 is fixed to the foundation 1 with a rotating axle 21 disposed on its top for rotating the set of connecting rods 3. The set of connecting rods 3 comprises a plurality of connecting rods 31, and each connecting rod is fixed with each other through screw mounting 32, insertion or other equivalent method so as to provide a stable and removable cylinder. The set of connecting rods 3 has its lower connecting rod 31 suitably and axially connected to the rotating axle 21 of the flagpole 2, so as to let the set of connecting rods 3 to move around the rotating axle 21 of the flagpole 2, and the set of connecting rods 3 has its topmost connecting rod disposed with a windmill 16 for driving a power generator 7 to provide power. The connecting rod 31 is hollow so as to conduct the electric wire of power generator 7 through the tunnel of the connecting rod 31 to the foundation 1 to maintain a uniform appearance and safety of the whole structure. The shaft mechanism 4 can be a labor saving mechanism, wherein the rotating arm 41 is axially connected with the upper shaft 42 at the axle 45. The upper shaft 42 has one end axially connected to the axle 46 at the lower end of the set of connecting rods 3, and the other end of the rotating arm 41 is axially connected to the axle 44 on the foundation 1. The labor-saving retractable device 5 has one end fixed to the foundation 1, and the pushing rod 43 is axially connected to the rotating arm 41 so as to let the labor-saving retractable device 5 drive the rotating arm 41 to rotate the set of connecting rods 3. The rotating arm 41 is axially connected to the upper shaft 42 and the pushing rod 43. The rotating arm 41 has one end axially connected to an axle 44 with the foundation 1, the other end of the rotating arm 41 is axially connected to an axle 45 with the upper shaft 42, and the upper shaft 42 has the other end axially connected to an axle 46 of the connecting rod 31 with the lower end of the set of connecting rods 3. Besides, one end of the pushing rod 43 is axially connected to an axle 47 with the rotating arm 41, so that when the labor-saving retractable device 5 extends or retracts, which drives the pushing rod 43 through the axle 51, and then the pushing rod 43 drives the rotating arm 41 through the axle 47 to rotate around the axle 44. Then the rotating arm 41 follows the curve the axle 45 travels to drive the upper shaft 42 to rotate around the rotating axle 21 of the flagpole 2, and finally the upper shaft 42 drives the set of connecting rods 3 to rotate through the axle 46. The rotating arm 41 and the labor-saving retractable device 5 form a shaft mechanism through the axle 44, the axle 45, the axle 46, the axle 47 and the axle 51 so as to drive the set of connecting rods 3, however, the mechanism comprises the rotating arm 41 and the labor-saving retractable device 5 is not the only possible embodiment of the present invention, and it is only for illustration. Besides, the rotating arm 41 can be designed to form in T shape, with its two ends connecting to the axle 44 and the axle 45 respectively, and let the axle 47 extending outwards from the rotating arm 41, therefore, the pushing rod 43 can turn with regard to the axle 47 to let the labor-saving retractable device 5 to be laid flat inside the foundation 1 for easy operation.

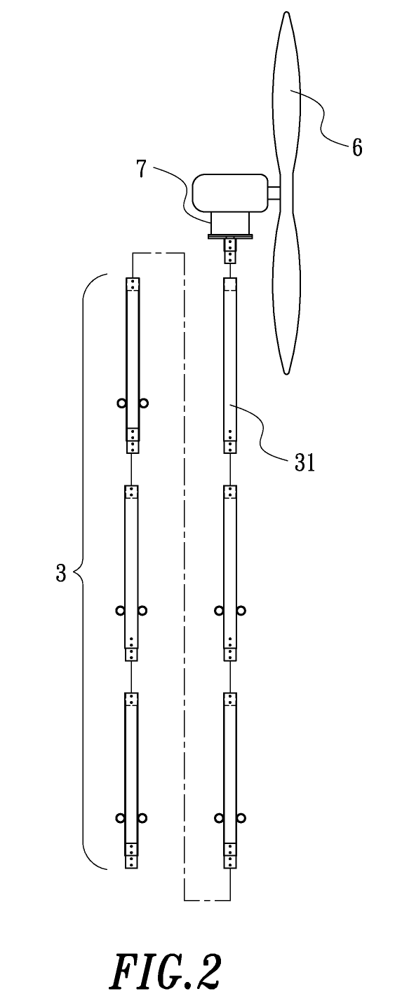

The present invention is characterized in that the whole structure can be disassembled for facilitating moving and transporting. The set of connecting rods 3 is consisted of a plurality of connect rods 31 (Please refer to FIG. 2), therefore it is easy to disassemble the structure for transporting and storing, and it is also viable to extend the length by adding more connecting rods for disposing windmill 16. Furthermore, the foundation 1 is easy to transport, as the user can add or reduce the weight of the foundation 1 easily.

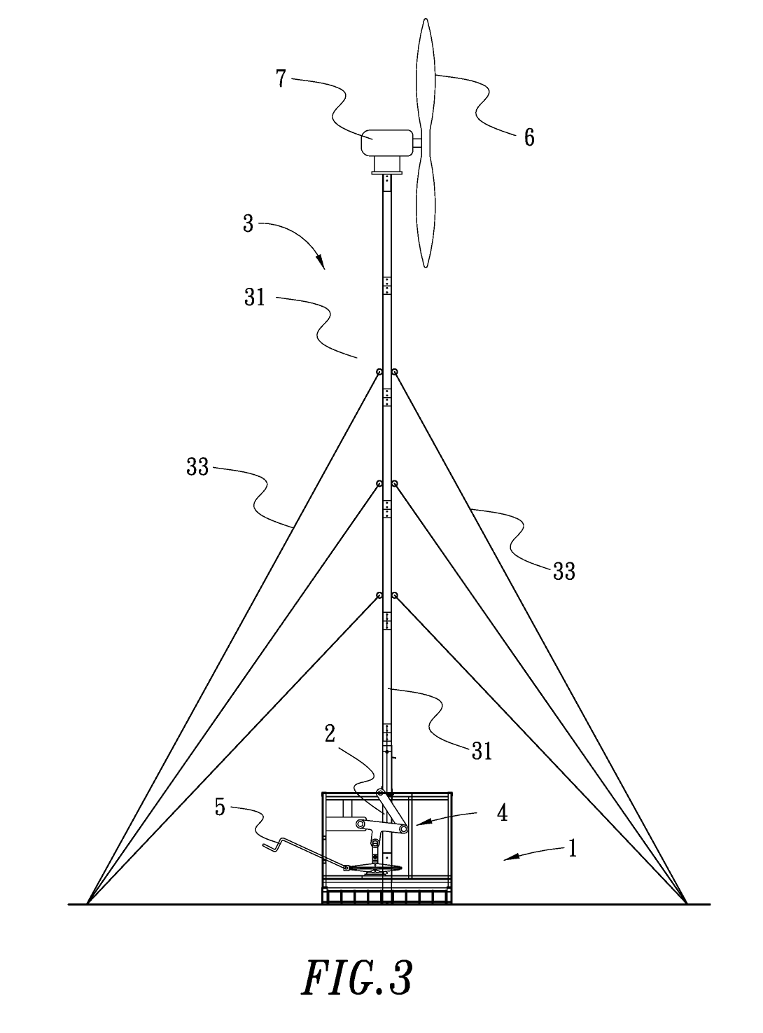

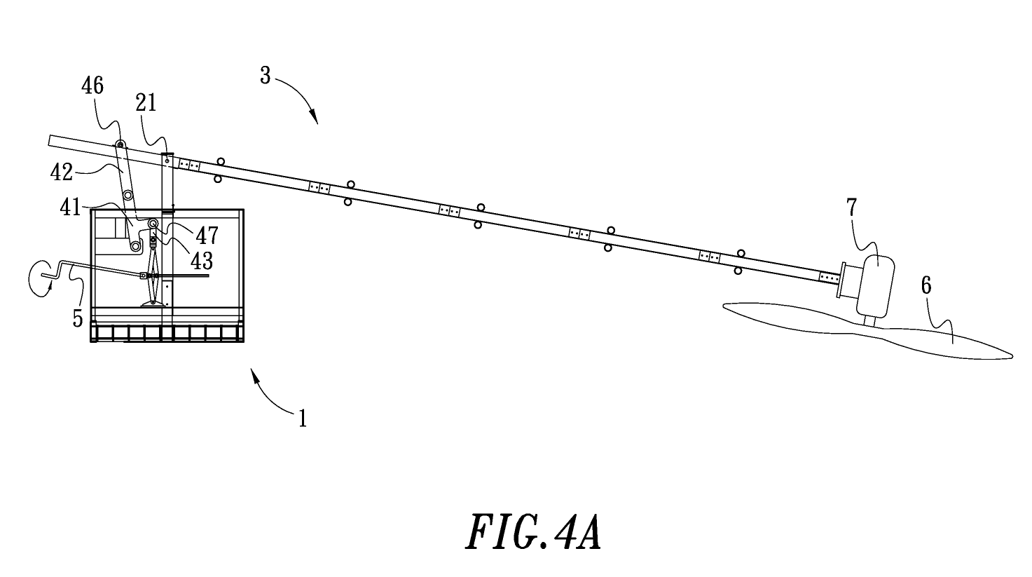

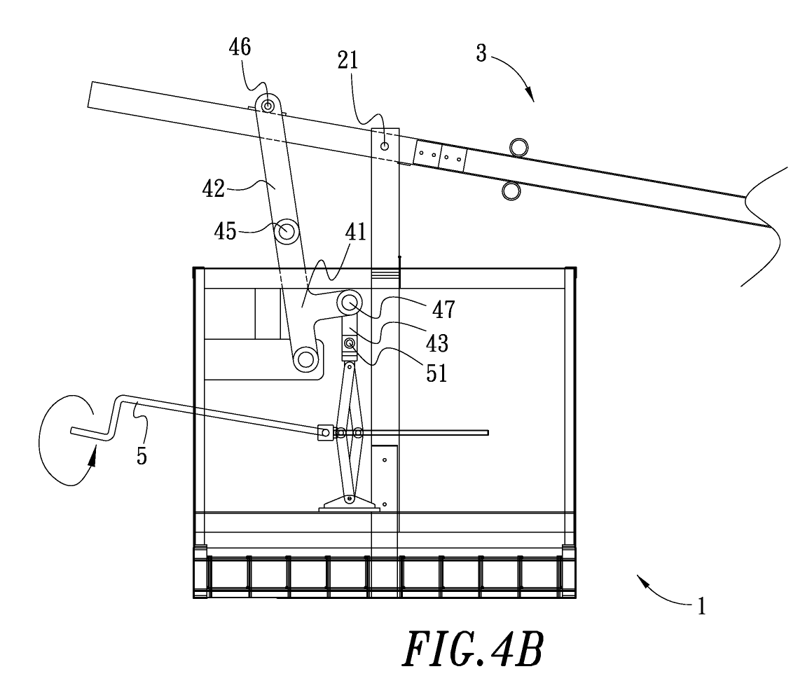

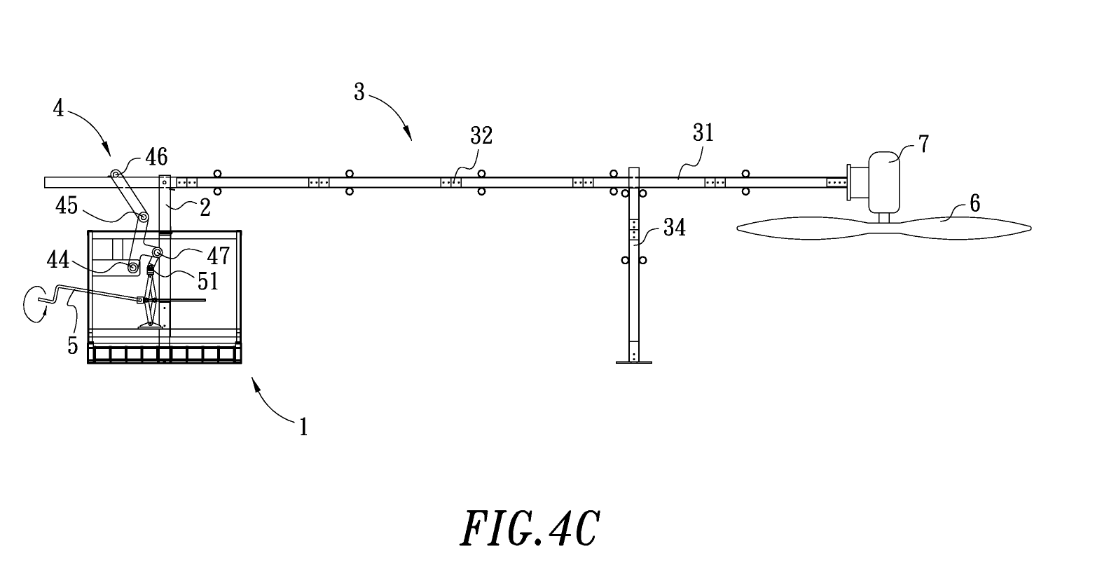

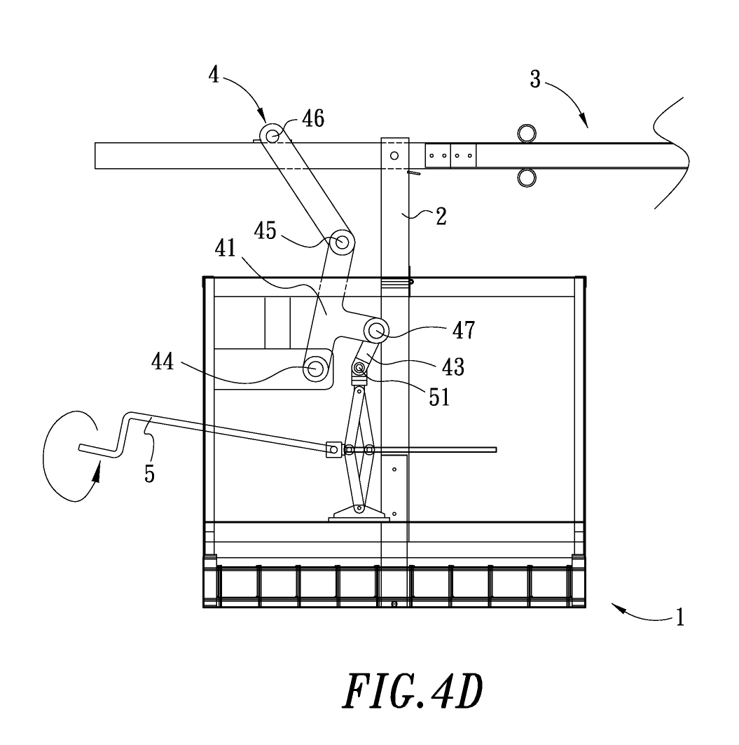

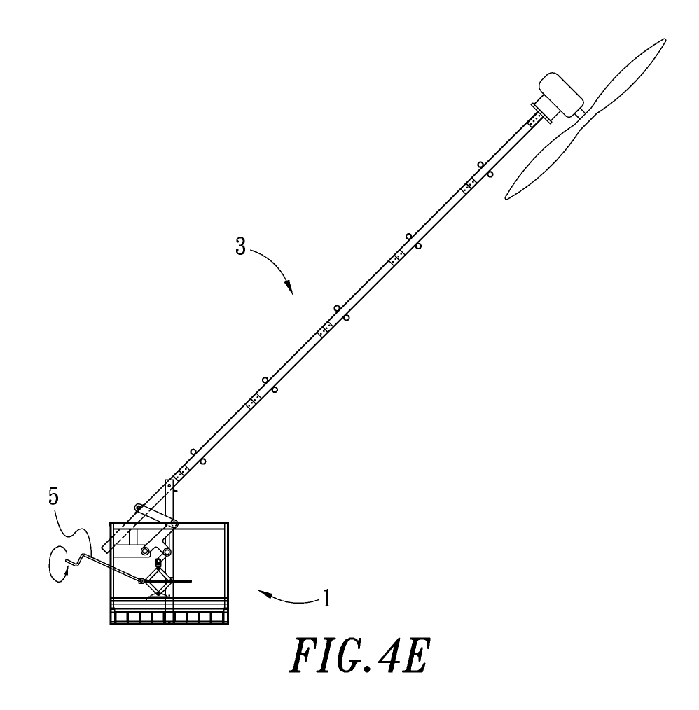

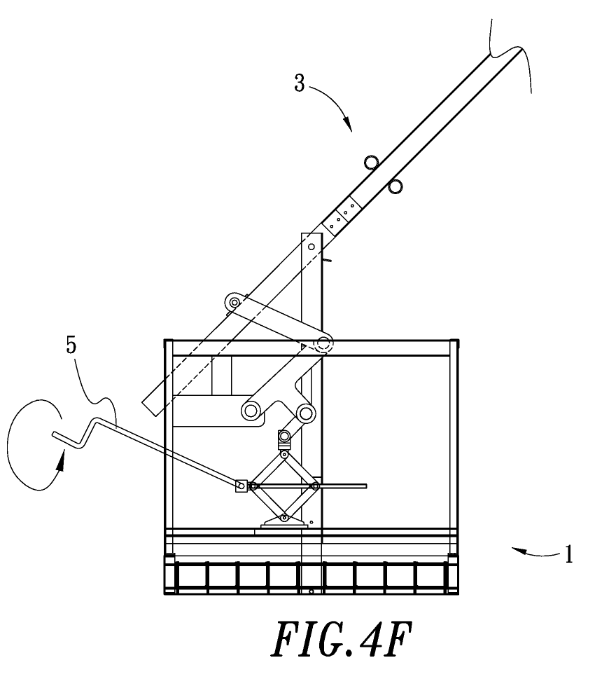

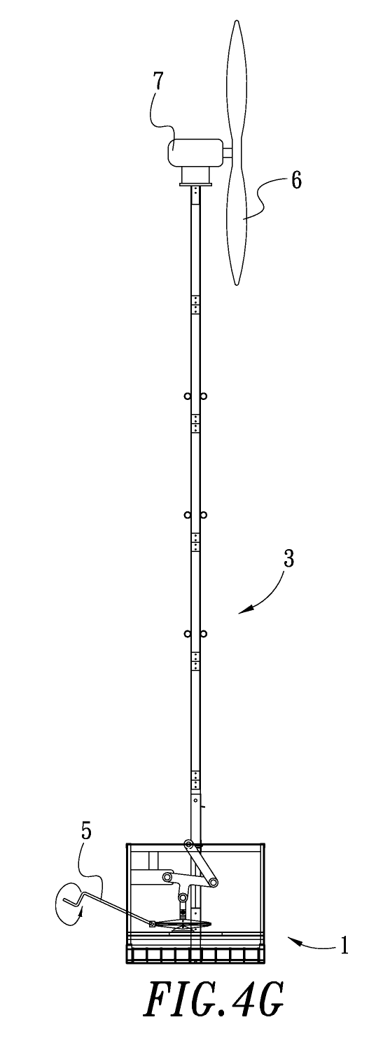

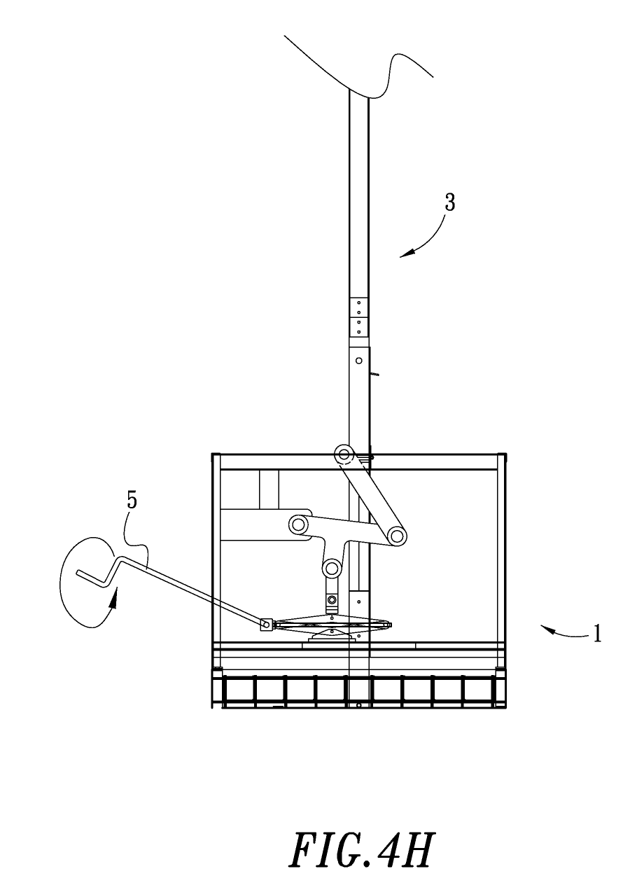

Please refer to FIG. 4A to FIG. 4H, when the integrated wind and solar power generating structure is assembled, the set of connecting rods 3 and the windmill 16 and the generator 7 on its top can be laid flat when there's a strong wind blowing, sand or tree branches flying around to prevent from damage and to extend the lifetime of the structure. The set of connecting rods 3 has each connecting rod disposed with a rope ring and a rope 33, and the rope extends and fixes to a fixed position on the ground when the set of connecting rods is erected or laid down, so that when the set of connecting rods 3 is laid down, it is laid upon the supporting rod 34 and tied up to the supporting rod and other immobile objects nearby (Please refer to FIG. 4C). During wind power generation, the labor-saving retractable device 5 can drive the pushing rod 43, the rotating arm 41, the upper shaft 42 in turn to rotate the set of connecting rods 3 around the rotating axle 21 of the flagpole 2 so as to let windmill 16 erected to face the wind to drive the power generator 7, and then the power generated will be transmitted to the foundation 1 for integration. During this time, it is viable to dispose a rope ring at each connecting rod 31 of the set of connecting rods 3 and use rope 33 to tie the set of connecting rods 3. When the set of connecting rods 3 is erected, the rope 33 will be pulled and fixed to the fixed position on the ground for stabilization (Please refer to FIG. 3). The labor-saving retractable device 5 can be any device which can apply force to the structure. In the embodiment, the labor-saving retractable device 5 is a jack, which can be replaced by a lever, a screw, a hydraulic press, a crane or other equivalent means.

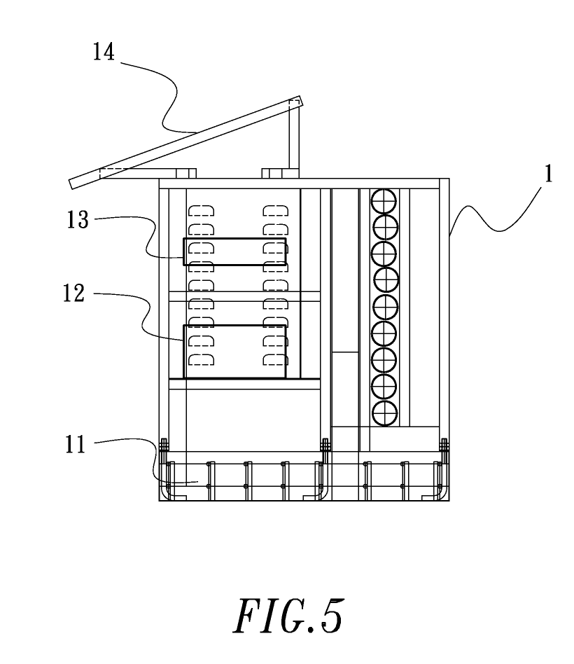

Besides, please refer to FIG. 5, a solar power generator 14 is disposed on the foundation 1 for generating solar power during daytime, and disposing the solar power generator 14 on the foundation 1 makes it easy to install, move or store. The foundation 1 has a container disposed therein for the battery 12 and other electronic controlling device 13, therefore it is viable to integrate the power from the power generator 7 and the solar power 14 for integrated storage and application so as to fully utilize the wind and solar power.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An integrated wind and solar power generating structure, comprising:
a foundation disposed on ground for supporting the weight of the structure, the foundation having a battery, an electronic controlling device disposed therein to receive power from a wind turbine and a solar panel;
a flagpole for a set of connecting rods to be installed and to rotate on the flagpole, the flagpole being fixed to the foundation;
the set of connecting rods comprising a plurality of connecting rods connected in series, wherein a connecting rod at the lower end is axially connected to the flagpole, and a windmill is installed on the topmost connecting rod for driving a wind turbine to generate wind power, wherein each connecting rod is hollow for conducting an electric wire connecting the wind turbine and the solar panel with the electronic controlling device;
a shaft mechanism having a first end axially connected to a lower end of the set of connecting rods and a second end axially connected to the foundation respectively, the shaft mechanism using an axially connected point on the flagpole as an axis to drive the set of connecting rods to rotate with regard to the foundation;
a labor-saving retractable device having an end axially connected to a rotating arm for extending or retracting the rotating arm to turn the set of connecting rods to erect or to lay down;
the solar panel disposed on top of the foundation, wherein power generated from the solar panel is transmitted through the electric wire to the electronic controlling device in the foundation and then to the battery to provide power source.

2. The integrated wind and solar power generating structure of claim 1, wherein the labor-saving retractable device is a jack, a screw, a labor-saving shaft mechanism, a hydraulic press, or a crane to drive the rotating arm.

3. The integrated wind and solar power generating structure of claim 1, wherein the shaft mechanism comprises a rotating arm, an upper shaft and a pushing rod, the rotating arm having one end axially connected to the foundation, the other end axially being connected to a first end of the upper shaft, while a second end of the upper shaft is axially connected to the lower end of the set of connecting rods; and the pushing rod having ends thereof axially connected to the rotating arm and the labor-saving retractable device respectively, when the retractable device is extending or retracting, the retractable device drives the pushing rod to turn the rotating arm, and then the rotating arm drives the upper shaft to turn the set of connecting rods.

4. The integrated wind and solar power generating structure of claim 1, wherein each one of the set of connecting rods connects with each other through screw mounting or insertion to be fixedly integrated.

5. The integrated wind and solar power generating structure of claim 1, wherein each connecting rod is hollow for conducting the electric wire from the set of connecting rods to the foundation.

6. The integrated wind and solar power generating structure of claim 1, wherein the set of connecting rods has each connecting rod disposed with a rope ring and a rope, the rope extends and fixes to a fixed position on the ground when the set of connecting rods is erected or laid down.

7. The integrated wind and solar power generating structure of claim 1, wherein the set of connecting rods is additionally disposed with a supporting rod, the supporting rod is fixed on the ground, so that when the set of connecting rods is laid down, the set of connecting rods is laid upon the supporting rod and tied up to the supporting rod and other immobile objects nearby.

8. The integrated wind and solar power generating structure of claim 1, wherein the solar panel is removably disposed on the foundation to easily retrieve the solar panel from a container and to dispose the solar panel on the foundation, and the solar panel is also easy to disassemble to be disposed inside the foundation when there's a strong wind blowing, sand or tree branches flying around, besides, electronic controlling device disposed within the foundation can expand a power capacity by enlarging the area of the solar panel.

9. The integrated wind and solar power generating structure of claim 1, wherein the rotating arm is formed in T shape for an axle connecting the pushing rod and the rotating arm to extend outward so as to let the labor-saving retractable device to lay flat inside the foundation.
